(19) United States
(12) Patent Application Publication
(10) Pub. No.: US 2025/0281908 A1
(43) Pub. Date: Sep. 11, 2025

(54) ELECTROCATALYST COMPOSITION AND PREPARATION METHOD THEREOF

(71) Applicant: INDUSTRIAL TECHNOLOGY RESEARCH INSTITUTE, Hsinchu (TW)

(72) Inventors: Shin-Liang KUO, Hsinchu City (TW); Chang-An CHEN, New Taipei City (TW)

(73) Assignee: INDUSTRIAL TECHNOLOGY RESEARCH INSTITUTE, Hsinchu (TW)

(21) Appl. No.: 18/883,626

(22) Filed: Sep. 12, 2024

(30) Foreign Application Priority Data
Mar. 6, 2024 (TW) 113108155

(51) Int. Cl. B01J 23/06; B01J 23/18; B01J 35/00; B01J 35/33; B01J 35/80; B01J 37/04

(52) U.S. Cl. CPC B01J 23/06; B01J 23/18; B01J 35/19; B01J 35/33; B01J 35/80; B01J 37/04

(57) ABSTRACT

An electrocatalyst composition is provided. The electrocatalyst composition includes a carrier and active substances, including zinc and bismuth, deposited on the surface of the carrier. The weight ratio of zinc to bismuth is between 0.001 and 0.025. The surface of bismuth includes completely oxidized bismuth (Bi³⁺) and incompletely oxidized bismuth (Bi²⁺), and the ratio of the incompletely oxidized bismuth to the completely oxidized bismuth is between 0.005 and 0.25.

### CROSS REFERENCE TO RELATED APPLICATIONS

This Application claims priority of Taiwan Patent Application No. 113108155, filed on Mar. 6, 2024, the entirety of which is incorporated by reference herein.

### TECHNICAL FIELD

The present disclosure relates to an electrocatalyst composition for electrochemical reduction of carbon dioxide and a preparation method thereof.

### BACKGROUND

In addition to developing carbon-reduction processes in chemical production technology, multinational companies are also looking to integrate carbon capture and utilization (CCU) technologies to replace the original petrochemical production process. This has come in response to the net-zero emissions by 2050. In order to expand the application of different derivatives of CCU, there has been international investment in the development of various reuse technologies. Electrochemical reduction process technology has also attracted more attention due to the promotion of renewable energy policies. Compared with the thermocatalytic process, electrochemical reaction is recognized as an environmentally friendly process. It has the characteristics of mild operating conditions and can be implemented through integration. It can also effectively utilize the remaining power from renewable energy and convert electrical energy into chemical energy for storage and application.

For electrocatalytic carbon dioxide conversion reactions, carbon dioxide is the molecule with the highest oxidation valence (+4 valence), so it must be converted into other chemicals, including carbon monoxide, formic acid, methanol, methane and other single-carbon chemicals, or acetone, acetic acid, etc., through reduction reactions. Chief among these, formic acid is widely used in agriculture, textiles, rubber, food and other industries, and is further regarded as a new source of liquid fuel and synthetic gas. It can also be used as a raw material that can be further converted into formate, formaldehyde, acrylic acid and other chemicals through derivatization reactions. However, since the electrochemical reduction reaction usually occurs in an aqueous solution, it is accompanied by a hydrogen evolution reaction (HER), resulting in low Faradaic efficiency.

In order to effectively accelerate the reaction rate, improve selectivity, and suppress side reactions (e.g., HER), the development and research of ideal formic acid electrocatalytic catalysts with excellent carbon dioxide reduction reaction activity and selectivity are particularly urgent in the current field of green chemistry research.

### SUMMARY

In accordance with one embodiment of the present disclosure, an electrocatalyst composition is provided. The electrocatalyst composition includes a carrier and active substances, including zinc and bismuth, deposited on the surface of the carrier. The weight ratio of zinc to bismuth is between 0.001 and 0.025. The surface of bismuth includes completely oxidized bismuth (Bi³⁺) and incompletely oxidized bismuth (Bi²⁺), and the ratio of the incompletely oxidized bismuth to the completely oxidized bismuth is between 0.005 and 0.25.

In one embodiment, the carrier includes carbon black, acetylene black, activated carbon, magnesium oxide, magnesium aluminum oxide, aluminum oxide, or a combination thereof.

In one embodiment, the completely oxidized bismuth (Bi³⁺) and the incompletely oxidized bismuth (Bi²⁺) exist in the form of bismuth oxide. In one embodiment, the active substances include crystalline bismuth or bismuth oxide. In one embodiment, the active substances include amorphous bismuth or bismuth oxide.

In one embodiment, the weight ratio of the active substances to the carrier is between 0.1 and 0.9.

In accordance with one embodiment of the present disclosure, a method for preparing an electrocatalyst composition is provided. The preparation method includes the following steps. A bismuth precursor, a zinc precursor, a chelating agent, and a carrier are mixed to prepare a first solution. A second solution containing a reducing agent is prepared. The second solution is slowly dropped into the first solution to prepare the disclosed electrocatalyst composition.

In one embodiment, the bismuth precursor includes bismuth nitrate (Bi(NO₃)₃·5H₂O). In one embodiment, the zinc precursor includes zinc chloride (ZnCl₂) or zinc acetate (Zn(CH₃COO)₂). In one embodiment, the chelating agent includes sodium citrate (Na₃C₆H₅O₇), citric acid, ethylenediaminetetraacetic acid (EDTA), sodium ethylenediaminetetraacetate (EDTA sodium), amino acids, ascorbic acid, or a combination thereof. In one embodiment, the carrier includes carbon black, acetylene black, activated carbon, magnesium oxide, magnesium aluminum oxide, aluminum oxide, or a combination thereof.

In one embodiment, the reducing agent includes sodium borohydride (NaBH₄), potassium borohydride (KBH₄), hydrazine, dimethylamine borane (DMAB), or a combination thereof.

In the zinc-bismuth composite-loaded catalyst according to one embodiment of the present disclosure, since the weight ratio of zinc to bismuth is between 0.001 and 0.025, and the ratio of incompletely oxidized bismuth (Bi²⁺) to completely oxidized bismuth (Bi³⁺) is between 0.005 and 0.25, the disclosed zinc-bismuth composite-loaded catalyst has better reaction selectivity for the electrocatalytic reduction of carbon dioxide (CO₂) to formic acid (HCOOH).

In the catalyst preparation method according to one embodiment of the present disclosure, bismuth-containing and zinc-containing compounds are used as precursors, and nanoparticles of the bismuth, bismuth oxides and bismuth oxides are deposited on the carrier through a chemical reduction method. The zinc-bismuth composite-loaded electrocatalyst is obtained through solid-liquid separation, deionized water cleaning, and low-temperature drying. One embodiment of the present disclosure provides a simple synthesis method to obtain a uniform composite-metal catalyst. The composite-metal catalyst inhibits the hydrogen evolution reaction (HER) and can effectively increase the potential difference between the carbon dioxide (CO₂) reduction reaction and the hydrogen evolution reaction to maintain better electrochemical performance.

In addition, during the preparation process, the amount of reducing agent added and the reduction reaction time greatly affect the composition ratio of bismuth atoms with different valences. Completely oxidized bismuth ions (Bi³⁺) easily form bismuth trioxide (Bi₂O₃) in the air. In an environment rich in carbon dioxide, Bi₂O₂CO₃ will be further formed, and the structure of Bi₂O₂CO₃ helps catalyze the formation of formic acid from carbon dioxide.

One embodiment of the present disclosure provides a catalyst composition with a relatively high potential difference (>0.5V) between the carbon dioxide reduction reaction and the hydrogen evolution reaction, and a preparation method thereof.

### DETAILED DESCRIPTION

Various embodiments or examples are provided in the following description to implement different features of the present disclosure. It should be understood that additional operations may be provided before, during, and/or after the described method. In accordance with some embodiments, some of the stages (or steps) described below may be replaced or omitted.

In this specification, the terms “about”, “around” and “substantially” typically mean a value is in a range of +/−15% of a stated value, typically a range of +/−10% of the stated value, typically a range of +/−5% of the stated value, typically a range of +/−3% of the stated value, typically a range of +/−2% of the stated value, typically a range of +/−1% of the stated value, or typically a range of +/−0.5% of the stated value. The stated value of the present disclosure is an approximate value. Namely, the meaning of “about”, “around” and “substantially” may be implied if there is no specific description of “about”, “around” and “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In accordance with one embodiment of the present disclosure, an electrocatalyst composition is provided. The electrocatalyst composition includes a carrier and active substances, including zinc and bismuth, on the surface of the carrier. In the active substances, the weight ratio of zinc to bismuth is between about 0.001 and about 0.025. The surface of bismuth includes completely oxidized bismuth (Bi³⁺) and incompletely oxidized bismuth (Bi²⁺), and the ratio of the incompletely oxidized bismuth to the completely oxidized bismuth (Bi²⁺/Bi³⁺) is between about 0.005 and about 0.25.

In one embodiment, the active substances are deposited on the surface of the carrier.

In one embodiment, the carrier includes carbon black, acetylene black, activated carbon, magnesium oxide, magnesium aluminum oxide, aluminum oxide, or a combination thereof.

In one embodiment, the completely oxidized bismuth (Bi³⁺) and the incompletely oxidized bismuth (Bi²⁺) exist as bismuth oxide. In one embodiment, the active substances include crystalline bismuth or bismuth oxide. In one embodiment, the active substances include amorphous bismuth or bismuth oxide.

In one embodiment, the weight ratio of the active substances to the carrier is between about 0.1 and about 0.9.

In accordance with one embodiment of the present disclosure, a method for preparing an electrocatalyst composition is provided. The preparation method includes the following steps. A bismuth precursor, a zinc precursor, a chelating agent, and a carrier are mixed to prepare a first solution. A second solution containing a reducing agent is prepared. The second solution is slowly dropped into the first solution to prepare an electrocatalyst composition.

In one embodiment, the bismuth precursor includes bismuth nitrate (Bi(NO₃)₃·5H₂O). In one embodiment, the zinc precursor includes zinc chloride (ZnCl₂) or zinc acetate (Zn(CH₃COO)₂). In one embodiment, the chelating agent includes sodium citrate (Na₃C₆H₅O₇), citric acid, ethylenediaminetetraacetic acid (EDTA), sodium ethylenediaminetetraacetate (EDTA sodium), amino acids, ascorbic acid, or a combination thereof. In one embodiment, the carrier includes carbon black, acetylene black, activated carbon, magnesium oxide, magnesium aluminum oxide, aluminum oxide, or a combination thereof.

In one embodiment, the reducing agent includes sodium borohydride (NaBH₄), potassium borohydride (KBH₄), hydrazine, dimethylamine borane (DMAB), or a combination thereof.

In one embodiment, the electrocatalyst composition includes the carrier and active substances, including zinc and bismuth, deposited on the surface of the carrier. In the active substances, the weight ratio of zinc to bismuth is between about 0.001 and about 0.025. The surface of bismuth includes completely oxidized bismuth (Bi³⁺) and incompletely oxidized bismuth (Bi²⁺), and the ratio of the incompletely oxidized bismuth to the completely oxidized bismuth is between about 0.005 and about 0.25.

In one embodiment, the completely oxidized bismuth (Bi³⁺) and the incompletely oxidized bismuth (Bi²⁺) exist as bismuth oxide. In one embodiment, the active substances include crystalline bismuth or bismuth oxide. In one embodiment, the active substances include amorphous bismuth or bismuth oxide.

In one embodiment, the weight ratio of the active substances to the carrier is between about 0.1 and about 0.9.

In one embodiment, bismuth nitrate (Bi(NO₃)₃·5H₂O) is selected as the bismuth precursor. In one embodiment, zinc chloride (ZnCl₂) or zinc acetate (Zn(CH₃COO)₂) is selected as the zinc precursor. In one embodiment, the chelating agent, for example sodium citrate (Na₃C₆H₅O₇), is added. In one embodiment, a carbon carrier is added and dispersed in an ultrasonic vibration tank for about 3 minutes to about 10 minutes, or about 5 minutes to about 7 minutes. In one embodiment, a chemical reducing agent, such as sodium borohydride (NaBH₄), is added. Then, the active substances are continuously subjected to a reduction reaction. The reaction time affects the morphology of the active substances on the surface of the carrier. A longer reaction time results in larger crystalline particles, while a shorter reaction time results in smaller crystalline particles. In one embodiment, the reaction time is greater than zero and less than or equal to 6 hours. In one embodiment, after the catalyst is reduced, the catalyst is washed with deionized water 3 to 5 times, and dried in an oven at 50° C. to 80° C. or 60° C. to 70° C. to obtain the zinc-bismuth composite-loaded electrocatalyst.

Composition analysis method of zinc-bismuth composite-loaded catalyst:

An x-ray photoelectron spectrometer (XPS) is used to analyze the valence information of elements on the surface of the catalyst. An energy dispersive spectrometer (EDS) of an electron microscope or an x-ray fluorescence spectrometer (XRF) is used to analyze the composition ratio of the catalyst elements.

Appearance and uniformity analysis method of zinc-bismuth composite-loaded catalyst:

A transmission electron microscopy (TEM) is used to observe the degree of aggregation of nanocrystals. An energy-dispersive x-ray spectroscopy (EDS) is used as the basis to examine whether elements are uniformly dispersed.

Crystallinity analysis method of zinc-bismuth composite-loaded catalyst:

An x-ray diffractometer (XRD) is used to analyze the crystallinity and the diffraction characteristic peaks of the catalyst.

Evaluation method of electrocatalytic properties of zinc-bismuth composite-loaded catalyst:

The catalyst is coated on a glassy carbon electrode. 0.5 M potassium hydrogen carbonate (KHCO₃) aqueous solution is used as an electrolyte. The electrolyte is exposed to carbon dioxide (CO₂) gas to evaluate the electrocatalytic effect. Meanwhile, an electrolyte of the same composition as aforementioned is exposed to nitrogen (N₂) to compare with the hydrogen evolution reaction (HER) (competitive reaction).

### EXAMPLES/COMPARATIVE EXAMPLES

### Example 1

1.5 g bismuth nitrate (Bi(NO₃)₃·5H₂O), 0.2 g zinc acetate (Zn(CH₃COO)₂), 1.5 g concentrated nitric acid, 45 g deionized water, 4 g sodium citrate (Na₃C₆H₅O₇) as a chelating agent, and 0.2 g carbon carrier were placed into a glass reactor equipped with a stirrer to prepare a first solution. 0.8 g sodium borohydride (NaBH₄) was added to 30 g deionized water to prepare a second solution. Then, the second solution was slowly dropped into the first solution to continuously react for 30 minutes. Then, the product was washed with deionized water 3 to 5 times, and dried in an oven at 60° C. to obtain the zinc-bismuth composite-loaded catalyst.

A transmission electron microscopy (TEM) and an energy-dispersive x-ray spectroscopy (EDS) were used to analyze the catalyst characteristics, and it can be seen that the nanometal particles are evenly distributed on the surface of the carbon carrier, and each element is evenly distributed. The content of each component in the zinc-bismuth composite-loaded catalyst and the electrocatalytic properties are listed in Tables 1, 2 and 3 below.

### Example 2

1.5 g bismuth nitrate (Bi(NO₃)₃·5H₂O), 0.4 g zinc acetate (Zn(CH₃COO)₂), 1.5 g concentrated nitric acid, 45 g deionized water, 4 g sodium citrate (Na₃C₆H₅O₇) as a chelating agent, and 0.2 g carbon carrier were placed into a glass reactor equipped with a stirrer to prepare a first solution. 0.82 g sodium borohydride (NaBH₄) was added to 30 g deionized water to prepare a second solution. Then, the second solution was slowly dropped into the first solution to continuously react for 15 minutes. Then, the product was washed with deionized water 3 to 5 times, and dried in an oven at 60° C. to obtain the zinc-bismuth composite-loaded catalyst.

A transmission electron microscopy (TEM) and an energy-dispersive x-ray spectroscopy (EDS) were used to analyze the catalyst characteristics, and it can be seen that the nanometal particles are evenly distributed on the surface of the carbon carrier, and each element is evenly distributed. The content of each component in the zinc-bismuth composite-loaded catalyst and the electrocatalytic properties are listed in Table 1 below.

### Example 3

1.5 g bismuth nitrate (Bi(NO₃)₃·5H₂O), 0.4 g zinc acetate (Zn(CH₃COO)₂), 1.5 g concentrated nitric acid, 45 g deionized water, 4 g sodium citrate (Na₃C₆H₅O₇) as a chelating agent, and 0.2 g carbon carrier were placed into a glass reactor equipped with a stirrer to prepare a first solution. 1.5 g sodium borohydride (NaBH₄) was added to 30 g deionized water to prepare a second solution. Then, the second solution was slowly dropped into the first solution to continuously react for 15 minutes. Then, the product was washed with deionized water 3 to 5 times, and dried in an oven at 60° C. to obtain the zinc-bismuth composite-loaded catalyst.

A transmission electron microscopy (TEM) and an energy-dispersive x-ray spectroscopy (EDS) were used to analyze the catalyst characteristics, and it can be seen that the nanometal particles are evenly distributed on the surface of the carbon carrier, and each element is evenly distributed. The content of each component in the zinc-bismuth composite-loaded catalyst and the electrocatalytic properties are listed in Table 1 below.

### Example 4

1.5 g bismuth nitrate (Bi(NO₃)₃·5H₂O), 0.8 g zinc acetate (Zn(CH₃COO)₂), 1.5 g concentrated nitric acid, 45 g deionized water, 4 g sodium citrate (Na₃C₆H₅O₇) as a chelating agent, and 0.2 g carbon carrier were placed into a glass reactor equipped with a stirrer to prepare a first solution. 0.82 g sodium borohydride (NaBH₄) was added to 15 g deionized water to prepare a second solution. Then, the second solution was slowly dropped into the first solution to continuously react for 3 hours. Then, the product was washed with deionized water 3 to 5 times, and dried in an oven at 70° C. to obtain the zinc-bismuth composite-loaded catalyst.

A transmission electron microscopy (TEM) and an energy-dispersive x-ray spectroscopy (EDS) were used to analyze the catalyst characteristics, and it can be seen that the nanometal particles are evenly distributed on the surface of the carbon carrier, and each element is evenly distributed. The content of each component in the zinc-bismuth composite-loaded catalyst and the electrocatalytic properties are listed in Table 2 below.

### Example 5

1.5 g bismuth nitrate (Bi(NO₃)₃·5H₂O), 0.1 g zinc acetate (Zn(CH₃COO)₂), 1.5 g concentrated nitric acid, 45 g deionized water, 4 g sodium citrate (Na₃C₆H₅O₇) as a chelating agent, and 0.2 g carbon carrier were placed into a glass reactor equipped with a stirrer to prepare a first solution. 0.2 g sodium borohydride (NaBH₄) was added to 7.5 g deionized water to prepare a second solution. Then, the second solution was slowly dropped into the first solution to continuously react for 6 hours. Then, the product was washed with deionized water 3 to 5 times, and dried in an oven at 50° C. to obtain the zinc-bismuth composite-loaded catalyst.

A transmission electron microscopy (TEM) and an energy-dispersive x-ray spectroscopy (EDS) were used to analyze the catalyst characteristics, and it can be seen that the nanometal particles are evenly distributed on the surface of the carbon carrier, and each element is evenly distributed. The content of each component in the zinc-bismuth composite-loaded catalyst and the electrocatalytic properties are listed in Table 2 below.

### Comparative Example 1

1.5 g bismuth nitrate (Bi(NO₃)₃·5H₂O), 0.4 g zinc acetate (Zn(CH₃COO)₂), 1.5 g concentrated nitric acid, 45 g deionized water, 4 g sodium citrate (Na₃C₆H₅O₇) as a chelating agent, and 0.2 g carbon carrier were placed into a glass reactor equipped with a stirrer to prepare a first solution. 0.82 g sodium borohydride (NaBH₄) was added to 30 g deionized water to prepare a second solution. Then, the second solution was slowly dropped into the first solution to continuously react for 8 hours. Then, the product was washed with deionized water 3 to 5 times, and dried in an oven at 50° C. to obtain the zinc-bismuth composite-loaded catalyst. According to the aforementioned analysis methods, the content of each component in the zinc-bismuth composite-loaded catalyst and the electrocatalytic properties are listed in Tables 1 and 2 below.

### Comparative Example 2

1.5 g bismuth nitrate (Bi(NO₃)₃·5H₂O), 0.4 g zinc acetate (Zn(CH₃COO)₂), 1.5 g concentrated nitric acid, 45 g deionized water, 3 g sodium citrate (Na₃C₆H₅O₇) as a chelating agent, and 0.2 g carbon carrier were placed into a glass reactor equipped with a stirrer to prepare a first solution. 0.21 g sodium borohydride (NaBH₄) was added to 30 g deionized water to prepare a second solution. Then, the second solution was slowly dropped into the first solution to continuously react for 12 hours. Then, the product was washed with deionized water 3 to 5 times, and dried in an oven at 50° C. to obtain the zinc-bismuth composite-loaded catalyst. According to the aforementioned analysis methods, the content of each component in the zinc-bismuth composite-loaded catalyst and the electrocatalytic properties are listed in Tables 1 and 2 below.

### Comparative Example 3

1.5 g bismuth nitrate (Bi(NO₃)₃·5H₂O), 0.3 g zinc acetate (Zn(CH₃COO)₂), 1.5 g concentrated nitric acid, 45 g deionized water, 3.5 g sodium citrate (Na₃C₆H₅O₇) as a chelating agent, and 0.2 g carbon carrier were placed into a glass reactor equipped with a stirrer to prepare a first solution. 0.21 g sodium borohydride (NaBH₄) was added to 30 g deionized water to prepare a second solution. Then, the second solution was slowly dropped into the first solution to continuously react for 24 hours. Then, the product was washed with deionized water 3 to 5 times, and dried in an oven at 50° C. to obtain the zinc-bismuth composite-loaded catalyst. According to the aforementioned analysis methods, the content of each component in the zinc-bismuth composite-loaded catalyst and the electrocatalytic properties are listed in Table 1 below.

### Comparative Example 4

1.5 g bismuth nitrate (Bi(NO₃)₃·5H₂O), 0.8 g zinc acetate (Zn(CH₃COO)₂), 1.5 g concentrated nitric acid, 45 g deionized water, 4 g sodium citrate (Na₃C₆H₅O₇) as a chelating agent, and 0.2 g carbon carrier were placed into a glass reactor equipped with a stirrer to prepare a first solution. 0.82 g sodium borohydride (NaBH₄) was added to 30 g deionized water to prepare a second solution. Then, the second solution was slowly dropped into the first solution to continuously react for 12 hours. Then, the product was washed with deionized water 3 to 5 times, and dried in an oven at 50° C. to obtain the zinc-bismuth composite-loaded catalyst. According to the aforementioned analysis methods, the content of each component in the zinc-bismuth composite-loaded catalyst and the electrocatalytic properties are listed in Table 2 below.

### Comparative Example 5

1.5 g bismuth nitrate (Bi(NO₃)₃·5H₂O), 1.5 g concentrated nitric acid, 45 g deionized water, 3 g sodium citrate (Na₃C₆H₅O₇) as a chelating agent, and 0.2 g carbon carrier were placed into a glass reactor equipped with a stirrer to prepare a first solution. 0.82 g sodium borohydride (NaBH₄) was added to 30 g deionized water to prepare a second solution. Then, the second solution was slowly dropped into the first solution to continuously react for 30 hours. Then, the product was washed with deionized water 3 to 5 times, and dried in an oven at 50° C. to obtain the bismuth-loaded catalyst. According to the aforementioned analysis methods, the content of each component in the bismuth-loaded catalyst and the electrocatalytic properties are listed in Table 3 below.

### Comparative Example 6

1 g bismuth nitrate (Bi(NO₃)₃·5H₂O), 0.125 g copper nitrate (Cu(NO₃)₂·3H₂O), 1.5 g concentrated nitric acid, 45 g deionized water, 4 g sodium citrate (Na₃C₆H₅O₇) as a chelating agent, and 0.2 g carbon carrier were placed into a glass reactor equipped with a stirrer to prepare a first solution. 0.5 g sodium borohydride (NaBH₄) was added to 30 g deionized water to prepare a second solution. Then, the second solution was slowly dropped into the first solution to continuously react for 24 hours. Then, the product was washed with deionized water 3 to 5 times, and dried in an oven at 50° C. to obtain the copper-bismuth composite-loaded catalyst. According to the aforementioned analysis methods, the content of each component in the copper-bismuth composite-loaded catalyst and the electrocatalytic properties are listed in Table 3 below.

### Comparative Example 7

1.5 g bismuth nitrate (Bi(NO₃)₃·5H₂O), 0.0375 g copper nitrate (Cu(NO₃)₂·3H₂O), 1.5 g concentrated nitric acid, 45 g deionized water, 3.5 g sodium citrate (Na₃C₆H₅O₇) as a chelating agent, and 0.2 g carbon carrier were placed into a glass reactor equipped with a stirrer to prepare a first solution. 0.82 g sodium borohydride (NaBH₄) was added to 30 g deionized water to prepare a second solution. Then, the second solution was slowly dropped into the first solution to continuously react for 24 hours. Then, the product was washed with deionized water 3 to 5 times, and dried in an oven at 50° C. to obtain the copper-bismuth composite-loaded catalyst. According to the aforementioned analysis methods, the content of each component in the copper-bismuth composite-loaded catalyst and the electrocatalytic properties are listed in Table 3 below.

### Comparative Example 8

1.5 g bismuth nitrate (Bi(NO₃)₃·5H₂O), 0.16 g silver nitrate (AgNO₃), 2 g concentrated nitric acid, 45 g deionized water, 3.5 g sodium citrate (Na₃C₆H₅O₇) as a chelating agent, and 0.2 g carbon carrier were placed into a glass reactor equipped with a stirrer to prepare a first solution. 0.1 g sodium borohydride (NaBH₄) was added to 30 g deionized water to prepare a second solution. Then, the second solution was slowly dropped into the first solution to continuously react for 24 hours. Then, the product was washed with deionized water 3 to 5 times, and dried in an oven at 50° C. to obtain the silver-bismuth composite-loaded catalyst. According to the aforementioned analysis methods, the content of each component in the silver-bismuth composite-loaded catalyst and the electrocatalytic properties are listed in Table 3 below.

### Comparative Example 9

2 g bismuth nitrate (Bi(NO₃)₃·5H₂O), 0.12 g indium chloride (InCl₃), 1.5 g concentrated nitric acid, 35 g deionized water, 6 g sodium citrate (Na₃C₆H₅O₇) as a chelating agent, and 0.2 g carbon carrier were placed into a glass reactor equipped with a stirrer to prepare a first solution. 1 g sodium borohydride (NaBH₄) was added to 30 g deionized water to prepare a second solution. Then, the second solution was slowly dropped into the first solution to continuously react for 8 hours. Then, the product was washed with deionized water 3 to 5 times, and dried in an oven at 50° C. to obtain the indium-bismuth composite-loaded catalyst. According to the aforementioned analysis methods, the content of each component in the indium-bismuth composite-loaded catalyst and the electrocatalytic properties are listed in Table 3 below.

The following illustrates the influence of the zinc/bismuth ratio in the zinc-bismuth composite-loaded catalyst on the electrocatalytic properties through Examples 1-3 and Comparative Examples 1-3. The content of each component in the zinc-bismuth composite-loaded catalyst and the electrocatalytic properties are listed in Table 1 below.

TABLE 1

| | Exam- | Exam- | Exam- | *Com. | Com. | Com. |
|---|---|---|---|---|---|---|
| | ple | ple | ple | Exam- | Exam- | Exam- |
| | 1 | 2 | 3 | ple 1 | ple 2 | ple 3 |
| Weight ratio | 0.77 | 0.69 | 0.74 | 0.76 | 0.77 | 0.74 |
| (active | | | | | | |
| substances/ | | | | | | |
| carrier) | | | | | | |
| Carrier | carbon | carbon | carbon | carbon | carbon | carbon |
| | black | black | black | black | black | black |
| XRD | bismuth/ | bismuth/ | amorphous | bismuth | bismuth/ | bismuth/ |
| crystallization | bismuth | bismuth | | (25.6) | bismuth | bismuth |
| characteristic | oxide | oxide | | | oxide | oxide |
| peaks (average | (27.2) | (24.0) | | | (45.5) | (40.9) |
| crystal size, | | | | | | |
| nm) | | | | | | |
| Metal element | zinc/ | zinc/ | zinc/ | zinc/ | zinc/ | zinc/ |
| composition | bismuth | bismuth | bismuth | bismuth | bismuth | bismuth |
| Zinc/Bismuth | 0.007 | 0.012 | 0.015 | 0.027 | 0.030 | 0.020 |
| ratio | | | | | | |
| Bi²⁺/Bi³⁺ ratio | 0.05 | 0.15 | 0.10 | 0.25 | 0.28 | 0.26 |
| CO₂ reduction | −1.47 | −1.48 | −1.44 | −1.69 | −1.61 | −1.50 |
| reaction | | | | | | |
| potential (V) | | | | | | |
| (vs. Ag/AgCl) | | | | | | |
| Hydrogen | −2.00 | −2.15 | −2.12 | −1.72 | −1.67 | −1.53 |
| evolution | | | | | | |
| reaction | | | | | | |
| potential (V) | | | | | | |
| (vs. Ag/AgCl) | | | | | | |
| Reaction | 0.53 | 0.67 | 0.68 | 0.03 | 0.06 | 0.03 |
| potential | | | | | | |
| difference (V) | | | | | | |

*Com. Example means Comparative Example

It can be seen from Table 1 that, in the disclosed zinc-bismuth composite-loaded catalyst, as shown in Examples 1-3, when the zinc/bismuth ratio is less than 0.025, and the ratio of incompletely oxidized bismuth (Bi²⁺) to completely oxidized bismuth (Bi³⁺) falls between 0.005 and 0.25, the carbon dioxide (CO₂) reduction reaction potential can be reduced to below 1.5V, and the hydrogen evolution reaction potential can be increased to above 2V. That is, the potential difference between the carbon dioxide reduction reaction and the hydrogen evolution reaction can reach more than 0.5V by adjusting the above-mentioned zinc/bismuth ratio and Bi²⁺/Bi³⁺ ratio. It can be proved from this that the disclosed zinc-bismuth composite-loaded catalyst has better reaction selectivity for the electrocatalytic reduction of carbon dioxide to formic acid than the catalysts provided in the comparative examples.

The following illustrates the influence of the ratio of incompletely oxidized bismuth (Bi²⁺) to completely oxidized bismuth (Bi³⁺) in the zinc-bismuth composite-loaded catalyst on the electrocatalytic properties through Examples 1, 4 and 5 and Comparative Examples 1, 2 and 4. The content of each component in the zinc-bismuth composite-loaded catalyst and the electrocatalytic properties are listed in Table 2 below.

TABLE 2

| | Exam- | Exam- | Exam- | *Com. | Com. | Com. |
|---|---|---|---|---|---|---|
| | ple | ple | ple | Exam- | Exam- | Exam- |
| | 1 | 4 | 5 | ple 1 | ple 2 | ple 4 |
| Weight ratio | 0.77 | 0.66 | 0.77 | 0.76 | 0.77 | 0.79 |
| (active | | | | | | |
| substances/ | | | | | | |
| carrier) | | | | | | |
| Carrier | carbon | carbon | carbon | carbon | carbon | carbon |
| | black | black | black | black | black | black |
| XRD | bismuth/ | bismuth | bismuth/ | bismuth | bismuth/ | amorphous |
| crystallization | bismuth | (34.1) | bismuth | (25.6) | bismuth | |
| characteristic | oxide | | oxide | | oxide | |
| peaks (average | (27.2) | | (27.3) | | (45.5) | |
| crystal size, | | | | | | |
| nm) | | | | | | |
| Metal element | zinc/ | zinc/ | zinc/ | zinc/ | zinc/ | zinc/ |
| composition | bismuth | bismuth | bismuth | bismuth | bismuth | bismuth |
| Zinc/Bismuth | 0.007 | 0.024 | 0.021 | 0.027 | 0.030 | 0.011 |
| ratio | | | | | | |
| Bi²⁺/Bi³⁺ ratio | 0.05 | 0.08 | 0.23 | 0.25 | 0.28 | 0.26 |
| CO₂ reduction | −1.47 | −1.42 | −1.42 | −1.69 | −1.61 | −1.60 |
| reaction | | | | | | |
| potential (V) | | | | | | |
| (vs. Ag/AgCl) | | | | | | |
| Hydrogen | −2.00 | −2.08 | −2.07 | −1.72 | −1.67 | −1.63 |
| evolution | | | | | | |
| reaction | | | | | | |
| potential (V) | | | | | | |
| (vs. Ag/AgCl) | | | | | | |
| Reaction | 0.53 | 0.66 | 0.65 | 0.03 | 0.06 | 0.03 |
| potential | | | | | | |
| difference (V) | | | | | | |

*Com. Example means Comparative Example

It can be seen from Table 2 that, in the disclosed zinc-bismuth composite-loaded catalyst, as shown in Examples 1, 4 and 5, when the zinc/bismuth ratio is less than 0.025, and the ratio of incompletely oxidized bismuth (Bi²⁺) to completely oxidized bismuth (Bi³⁺) falls between 0.005 and 0.25, the carbon dioxide (CO₂) reduction reaction potential can be reduced to below 1.5V, and the hydrogen evolution reaction potential can be increased to above 2V. That is, the potential difference between the carbon dioxide reduction reaction and the hydrogen evolution reaction can reach more than 0.5V by adjusting the above-mentioned zinc/bismuth ratio and Bi²⁺/Bi³⁺ ratio. In addition, the catalyst provided in Comparative Example 1 has a ratio of incompletely oxidized bismuth (Bi²⁺) to completely oxidized bismuth (Bi³⁺) of 0.25. Nonetheless, the zinc/bismuth ratio in Comparative Example 1 is higher than 0.025; it turns out that the potential difference between the carbon dioxide reduction reaction and the hydrogen evolution reaction is only 0.03V. It can be proved from this that the disclosed zinc-bismuth composite-loaded catalyst has better reaction selectivity for the electrocatalytic reduction of carbon dioxide to formic acid than the catalysts provided in the comparative examples.

The following illustrates the influence of various doping elements in the bismuth-loaded catalyst on the electrocatalytic properties through Example 1 and Comparative Examples 5-9. The content of each component in the bismuth-loaded catalyst and the electrocatalytic properties are listed in Table 3 below.

TABLE 3

| | Exam- | *Com. | Com. | Com. | Com. | Com. |
|---|---|---|---|---|---|---|
| | ple | Exam- | Exam- | Exam- | Exam- | Exam- |
| | 1 | ple 5 | ple 6 | ple 7 | ple 8 | ple 9 |
| Weight ratio | 0.77 | 0.69 | 0.73 | 0.59 | 0.70 | 0.78 |
| (active | | | | | | |
| substances/ | | | | | | |
| carrier) | | | | | | |
| Carrier | carbon | carbon | carbon | carbon | carbon | carbon |
| | black | black | black | black | black | black |
| XRD | bismuth/ | bismuth | bismuth | bismuth | bismuth | bismuth |
| crystallization | bismuth | (27.3) | (27.2) | (9.0) | (10.0) | (27.1) |
| characteristic | oxide | | | | | |
| peaks (average | (27.2) | | | | | |
| crystal size, | | | | | | |
| nm) | | | | | | |
| Metal element | zinc/ | bismuth | copper/ | copper/ | silver/ | indium/ |
| composition | bismuth | | bismuth | bismuth | bismuth | bismuth |
| Zinc/Bismuth | 0.007 | — | — | — | — | — |
| ratio | | | | | | |
| Bi²⁺/Bi³⁺ ratio | 0.05 | — | — | — | — | — |
| CO₂ reduction | −1.47 | −1.47 | −1.72 | −1.75 | −1.49 | −1.44 |
| reaction | | | | | | |
| potential (V) | | | | | | |
| (vs. Ag/AgCl) | | | | | | |
| Hydrogen | −2.00 | −1.70 | −1.85 | −1.79 | −1.73 | −1.71 |
| evolution | | | | | | |
| reaction | | | | | | |
| potential (V) | | | | | | |
| (vs. Ag/AgCl) | | | | | | |
| Reaction | 0.53 | 0.23 | 0.13 | 0.04 | 0.24 | 0.27 |
| potential | | | | | | |
| difference (V) | | | | | | |

*Com. Example means Comparative Example

It can be seen from Table 3 that, in the disclosed zinc-bismuth composite-loaded catalyst, as shown in Example 1, when the zinc/bismuth ratio is less than 0.025, and the ratio of incompletely oxidized bismuth (Bi²⁺) to completely oxidized bismuth (Bi³⁺) falls between 0.005 and 0.25, the carbon dioxide (CO₂) reduction reaction potential can be reduced to 1.47V, and the hydrogen evolution reaction potential can be increased to 2V. That is, the potential difference between the carbon dioxide reduction reaction and the hydrogen evolution reaction can reach more than 0.5V by adjusting the above-mentioned zinc/bismuth ratio and Bi²⁺/Bi³⁺ ratio. In addition, the catalysts provided in Comparative Examples 5-9, all constituent element combinations other than zinc/bismuth (for example, bismuth, copper/bismuth, silver/bismuth, and indium/bismuth). The results of Comparative Examples 5-9 show that the potential difference between the carbon dioxide reduction reaction and the hydrogen evolution reaction is only 0.27V at the highest. It can be proved from this that the disclosed zinc-bismuth composite-loaded catalyst has better reaction selectivity for the electrocatalytic reduction of carbon dioxide to formic acid than the catalysts provided in the comparative examples.

In the zinc-bismuth composite-loaded catalyst according to one embodiment of the present disclosure, since the weight ratio of zinc to bismuth is between 0.001 and 0.025, and the ratio of incompletely oxidized bismuth (Bi²⁺) to completely oxidized bismuth (Bi³⁺) is between 0.005 and 0.25, the disclosed zinc-bismuth composite-deposited catalyst has better reaction selectivity for the electrocatalytic reduction of carbon dioxide (CO₂) to formic acid (HCOOH).

In the catalyst preparation method according to one embodiment of the present disclosure, bismuth-containing and zinc-containing compounds are used as precursors, and nanoparticles of bismuth/zinc and/or their oxides are deposited on the carrier through a chemical reduction method. The zinc-bismuth composite-loaded electrocatalyst is obtained through solid-liquid separation, deionized water cleaning, and low-temperature drying. One embodiment of the present disclosure provides a simple synthesis method to obtain a uniform composite-metal catalyst. The composite-metal catalyst inhibits the hydrogen evolution reaction (HER) and can effectively increase the potential difference between the carbon dioxide (CO₂) reduction reaction and the hydrogen evolution reaction to maintain better electrochemical performance.

In addition, during the preparation process, the amount of reducing agent added greatly affects the composition ratio of bismuth atoms with different valences. Completely oxidized bismuth ions (Bi³⁺) easily form the structure of bismuth trioxide (Bi₂O₃) in the air. In an environment rich in carbon dioxide, Bi₂O₂CO₃ will be further formed, and the structure of Bi₂O₂CO₃ helps catalyze the formation of formic acid from carbon dioxide.

One embodiment of the present disclosure provides a catalyst composition with a relatively high potential difference (>0.5V) between the carbon dioxide reduction reaction and the hydrogen evolution reaction, and a preparation method thereof.

Although some embodiments of the present disclosure and their advantages have been described in detail, it should be understood that various changes, substitutions and alterations can be made herein without departing from the spirit and scope of the disclosure as defined by the appended claims. The features of the various embodiments can be used in any combination as long as they do not depart from the spirit and scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods or steps. In addition, each claim constitutes an individual embodiment, and the claimed scope of the present disclosure includes the combinations of the claims and embodiments. The scope of protection of present disclosure is subject to the definition of the scope of the appended claims. Any embodiment or claim of the present disclosure does not need to meet all the purposes, advantages, and features disclosed in the present disclosure.

What is claimed is:

1. An electrocatalyst composition, comprising:
a carrier having a surface; and
active substances comprising zinc and bismuth and deposited on the surface of the carrier,
wherein a weight ratio of zinc to bismuth is between 0.001 and 0.025, and
wherein a surface of bismuth comprises completely oxidized bismuth (Bi³⁺) and incompletely oxidized bismuth (Bi²⁺), and a ratio of the incompletely oxidized bismuth to the completely oxidized bismuth is between 0.005 and 0.25.

2. The electrocatalyst composition as claimed in claim 1, wherein the carrier comprises carbon black, acetylene black, activated carbon, magnesium oxide, magnesium aluminum oxide, aluminum oxide, or a combination thereof.

3. The electrocatalyst composition as claimed in claim 1, wherein the completely oxidized bismuth (Bi³⁺) and the incompletely oxidized bismuth (Bi²⁺) exist in a form of bismuth oxide.

4. The electrocatalyst composition as claimed in claim 1, wherein the active substances comprise crystalline bismuth or bismuth oxide.

5. The electrocatalyst composition as claimed in claim 1, wherein the active substances comprise amorphous bismuth or bismuth oxide.

6. The electrocatalyst composition as claimed in claim 1, wherein a weight ratio of the active substances to the carrier is between 0.1 and 0.9.

7. A method for preparing an electrocatalyst composition, comprising:
mixing a bismuth precursor, a zinc precursor, a chelating agent, and a carrier to prepare a first solution;
preparing a second solution containing a reducing agent; and
slowly dropping the second solution into the first solution to proceed a reaction to prepare an electrocatalyst composition,
wherein the electrocatalyst composition comprises:
the carrier; and
active substances comprising zinc and bismuth and deposited on a surface of the carrier,
wherein a weight ratio of zinc to bismuth is between 0.001 and 0.025, and
wherein a surface of bismuth comprises completely oxidized bismuth (Bi³⁺) and incompletely oxidized bismuth (Bi²⁺), and a ratio of the incompletely oxidized bismuth to the completely oxidized bismuth is between 0.005 and 0.25.

8. The method for preparing an electrocatalyst composition as claimed in claim 7, wherein the bismuth precursor comprises bismuth nitrate (Bi(NO₃)₃·5H₂O).

9. The method for preparing an electrocatalyst composition as claimed in claim 7, wherein the zinc precursor comprises zinc chloride (ZnCl₂) or zinc acetate (Zn(CH₃COO)₂).

10. The method for preparing an electrocatalyst composition as claimed in claim 7, wherein the chelating agent comprises sodium citrate (Na₃C₆H₅O₇), citric acid, ethylenediaminetetraacetic acid, sodium ethylenediaminetetraacetate, amino acids, ascorbic acid, or a combination thereof.

11. The method for preparing an electrocatalyst composition as claimed in claim 7, wherein the carrier comprises carbon black, acetylene black, activated carbon, magnesium oxide, magnesium aluminum oxide, aluminum oxide, or a combination thereof.

12. The method for preparing an electrocatalyst composition as claimed in claim 7, wherein the reducing agent comprises sodium borohydride (NaBH₄), potassium borohydride (KBH₄), hydrazine, dimethylamine borane, or a combination thereof.

13. The method for preparing an electrocatalyst composition as claimed in claim 7, wherein the completely oxidized bismuth (Bi³⁺) and the incompletely oxidized bismuth (Bi²⁺) exist in a form of bismuth oxide.

14. The method for preparing an electrocatalyst composition as claimed in claim 7, wherein the active substances comprise crystalline bismuth or bismuth oxide.

15. The method for preparing an electrocatalyst composition as claimed in claim 7, wherein the active substances comprise amorphous bismuth or bismuth oxide.

16. The method for preparing an electrocatalyst composition as claimed in claim 7, wherein a weight ratio of the active substances to the carrier is between 0.1 and 0.9.

17. The method for preparing an electrocatalyst composition as claimed in claim 7, wherein the reaction has a reaction time which is greater than zero and less than or equal to 6 hours.
